(19) United States
(12) Patent Application Publication
(10) Pub. No.: US 2012/0296838 A1
(43) Pub. Date: Nov. 22, 2012

(54) CONTROLLED COMMUNICATION SYSTEM

(75) Inventor: Harm van der Nol, Mount Waverley (AU)

(73) Assignee: DOT COM VENTURES PTY. LTD., Mount Waverley, Victoria (AU)

(21) Appl. No.: 13/576,739

(22) PCT Filed: Dec. 23, 2010
(86) PCT No.: PCT/AU2010/001733

§ 371 Date: Aug. 9, 2012

(30) Foreign Application Priority Data
Feb. 2, 2010 (AU) 2010900403

(51) Int. Cl. G06Q 99/00

(52) U.S. Cl. 705/319

(57) ABSTRACT

The invention describes a system of controlled communication providing a method of identifying and meeting unknown persons. The method includes the steps of: providing a personal display means for wearing by a first person; providing a distinctive identifying element on the personal display means allowing a second person to identify the distinctive identifying element; providing a database for receiving details from a plurality of people related to a plurality of the identified distinctive identifying elements; allowing the second person to enter details of the identified distinctive identifying element to retrieve the details of first person; receiving details from the second person; automatically providing details to the first person of the identification by the second person and details of the second person allowing review of the second person by the first person and selective contact by the first person to the second person.

### FIELD OF THE INVENTION

This invention relates to controlled communication system providing an identification means and in particular to a method of identifying and meeting unknown persons.

Whilst the invention may be applied to a range of uses, for convenience sake it shall be described herein in terms of an identification means and in particular to a method of identifying and meeting unknown persons as a social communication method.

### BACKGROUND TO THE INVENTION

Social networking sites have become increasingly popular. Such sites are used in order to assist and create a general avenue to help like-minded individuals meet, form clubs and organisations, create friendships, business relationships and for meeting and dating purposes. In light of the problems and difficulties in meeting the ‘right’ one, singles are looking for social networking sites that provide a safe and successful avenue to assist them in finding their match.

It is difficult in this day and age to determine whether a person you are introduced to for the first time is looking for a relationship, the type of relationship they are after and what values, characteristics and personality traits they are looking for in a prospective partner. Such questions are often difficult to ask, particularly under inappropriate, difficult or cultural circumstances or when the fear of rejection prevents individuals in taking any steps in introducing themselves. The prior art has provided limited avenues which attempt to address such issues.

Currently, social networking and dating sites providing for the opportunity to meet prospective partners make it easy for individuals to claim to be someone who they are not. Essentially, this means that an honest user could be starting an online relationship with someone who is not as they look in their photos or their personality is not as they described. Therefore, false images or representations are provided and the honest user is required to judge members on such representations. Current networking sites do not provide the medium nor, have the capacity, in which to allow a user to make more accurate and honest determinations of another user by viewing their personality and mannerisms and how they interact to the situation around them.

While this will not only lead to disappointment once communication between the online users intensifies, it could also lead to danger particularly where the users meet or where the honest user is deceived in providing intimate or sensitive information.

In one approach the prospective social networking person is required to provide on their person a badge whereby the badge provides a statement such as “I'm Available”. This causes a significant disadvantage to users who feel demoralised or embarrassed to wear such a badge and in some circumstances and situations can be rejected, discriminated or ridiculed by those around them.

Further, such a feature requires individuals who are attracted or interested in the badge wearer to approach them personally and directly in a face-to-face manner. This provides difficulties in that people can feel embarrassed to approach the individual wearing the badge, particularly where the individual is with a group of other individuals, thereby risking public embarrassment and rejection. This can raise considerable emotional stress. In addition, it does not provide the badge wearer with sufficient information and time in which to determine whether the admirer approaching them is an acceptable person to proceed with a meeting or date or relationship.

In particular, under normal social interactions it can be difficult and embarrassing to strike up a conversation with someone who is uninterested but polite to continue with the conversation. Time can be wasted in pursuing such an individual.

Further, a significant disadvantage of the prior art is the inability to determine another's attitude, morals, values and interests at the outset. Particularly in long term relationships where the issues of child rearing and career opportunities are not raised in the early periods of a relationship, when finally raised it can result in break ups and frustration at the time wasted with a partner who did not share the same values.

Accordingly, it is an object of the present invention to overcome or at least ameliorate one or more of the disadvantages of the prior art.

### SUMMARY OF THE INVENTION

The present invention provides an identification means in the form of a personal display means with a distinctive identifying element such that a passerby can determine the distinctive identifying element without necessarily approaching and meeting the person.

The invention further provides for a system of controlled communication providing a method of identifying and meeting unknown persons including the steps of: providing a personal display means for wearing by a first person; providing a distinctive identifying element on the personal display means allowing a second person to identify a distinctive identifying element of a viewed display means; providing a database for receiving details from a plurality of people related to one of a plurality of the identified distinctive identifying elements of a plurality of personal display means each associated and wearable by respective ones of the plurality of people including the first person; allowing the second person to enter details of the identified distinctive identifying element of the viewed display means by an access means to the database; and the access means retrieving from the database details of first person related to the distinctive identifying element of the viewed display means; the access means receiving details from the second person; automatically providing details to the first person of the identification by the second person and details of the second person allowing review of the second person by the first person and selective contact by the first person to the second person; whereby a communication between unrelated first and second persons can be undertaken with each having opportunity for review prior to selective interaction between each other.

Such a system of controlled communication provides a personal display means in the form of a bracelet that is wearable and has a distinctive identifying element and which is an identification means.

Further, the personal display means can be a watch, badge, a t-shirt, a jacket or pant pocket, backpack, business car, car registration plates, bumper sticker, key rings, mobile phones, mobile phone tags, temporary or permanent tattoos or a combination thereof.

The controlled communication further allows the personal display means to provide instant communication between the user initiator and the selected user. In addition, the personal display means can display information other than the personal display means including a trade mark, logo, users contact details and the like.

It is intended that the distinctive identifying element is unique and can be in the form of a series of colours, shapes and/or numbers or other identity code means whereby the size and type of distinctive identifying element allows viewing from a distance such that a passerby can determine the distinctive identifying element without necessarily approaching and meeting the person.

A further feature of the system of controlled communication provides for the distinctive identifying element to be in the form of a radio frequency identification chip, barcode, symbol, series of shapes and colours, an image, phrase or alphanumerical codes or a combination thereof.

The system of controlled communication further provides a registration process comprising the steps of: providing internal data; providing payment; and creating a personal profile page. The internal data includes the user's personal details, the user's privacy settings, user's information to be disclosed on their websites including their preferences or desired qualities in a user initiator. In addition the internal data can include a user's profile page.

The system of controlled communication further provides for a database. The database stores the distinctive identifying elements and users details corresponding to the distinctive identifying element. The database further provides a search means in which to find the details of the user correlating to the searched distinctive identifying element.

The invention further provides a communication means for controlled communication including: an access means for inputting into the communication means a distinctive identifying element of a personal display means of one of a plurality of users; a database of a collection of data of user information associated with respective distinctive identifying elements of the plurality of users; a search means for receiving the inputted distinctive identifying element and comparing with the plurality of distinctive identifying elements being stored in the database allowing a search to identify the selected user corresponding to the determined distinctive identifying element; a first output means for outputting from the database providing a means of accessing a selected users internal data and being visible to a initiating user for determination and in a position adequately representing the selected user; the access means able to receive a further input from the initiating user to provide input data of user information of the initiating user; a second output means for opening of communication channel to the selected user and for sending the data input of user information of the initiating user; whereby the controlled communication along communication channels between the user initiator and the selected user assists in the development of an online relationship at the selective choice of the selected user reviewing the data of user information of the initiating user.

The invention further provides a system of selective communication comprising of: providing input data by a user to generate the allocation of a distinctive identifying element to the user; displaying the distinctive identifying element on at least one identification means for transporting by the user; providing a database storing the distinctive identifying element allocated to the user and allowing access to a limited profile of the user's input data; whereby the system of selective communication allows a relationship between at least two users through the use of the distinctive identifying elements thereby allowing one of the at least two users to identify and record the distinctive identifying element without directly approaching the second of the at least two users but indirectly through the use of the system of selective communication.

The system for selective communication provides for an identification means in the form of a personal display means with a distinctive identifying element such that a passerby can determine the distinctive identifying element without necessarily approaching and meeting the person. The personal display means is wearable. In addition the personal display means is a bracelet, a watch, badge, a t-shirt, a jacket or pant pocket, backpack, business car, car registration plates, bumper sticker, key rings, mobile phones, mobile phone tags, temporary or permanent tattoos or a combination thereof. As such the invention provides for one of the at least two users to identify and record the distinctive identifying element without directly approaching the second of the at least two users is the user initiator. The personal display means can therefore allow instant communication between the user initiator and the selected user in a predefined vicinity.

The second of the at least two users whose distinctive identifying element has been recorded is the selected user. It is intended that the distinctive identifying element is unique.

The system of selective communication further provides for a personal display means which can display information other than the distinctive identifying element including trade mark, logo, users contact details and the like.

The system of selective communication provides for the distinctive identifying element to be in the form of a series of colours, shapes and/or numbers or other identity code means whereby the size and type of distinctive identifying element allows viewing from a distance such that a passerby can determine the distinctive identifying element without necessarily approaching and meeting the person.

The distinctive identifying element can further be in the form of a radio frequency identification chip, barcode, symbol, series of shapes and colours, an image, phrase or alphanumerical codes or a combination thereof.

The selective communication provides for a registration process compromising the steps of: providing internal data; providing payment; and creating a personal profile page.

The internal data includes the user's personal details, the user's privacy settings, and user's information to be disclosed on their websites including their preferences or desired qualities in a user initiator. The internal data also includes a user's profile page.

The system of selective communication further provides a database. The database stores the distinctive identifying element. The database further provides a search means in which to find the details of the user correlating to the searched distinctive identifying element.

The system of selective communication further provides for the use of the identification means in the system of selective communication, the use comprising of a personal display means with a distinctive identifying element such that a user initiator can determine the distinctive identifying element without necessarily approaching and meeting the selected user and upon determining the distinctive identifying element the user initiator can search the database to access a selected user's internal data and initiate communication.

The system of selective communication provides for the use of the identification means in the system of selective communication comprising of: a personal display means with a distinctive identifying element; the distinctive identifying element being visible to a user initiator for determination and in a position adequately representing the selected user; the distinctive identifying element being stored in the database allowing a search to identify the selected user corresponding to the determined distinctive identifying element; the database providing a means of accessing a selected user's internal data and opening of communication channels; whereby the opening of communication channels between the user initiator and the selected user assists in the development of an online relationship.

The system of selective communication allows the identification means to be applied for use as a selective communication system allowing the selective interaction of the user initiator and the selected user for such purposes as friendship, dating, networking and/or developing workplace relations.

### BRIEF DESCRIPTION OF THE DRAWINGS

In order that the invention can be more readily understood an embodiment will be described by way of non-limiting example with reference to the drawings wherein:

FIG. 1 provides a diagrammatic illustration of the method of identifying and meeting unknown persons.

FIG. 2 provides a diagrammatic illustration of the registration and communication process undertaken by the user initiator.

FIG. 3 provides a diagrammatic illustration of the registration and communication process undertaken by the selected user.

FIG. 4 provides a diagrammatic illustration of the components and operation of the communication means for controlled communication.

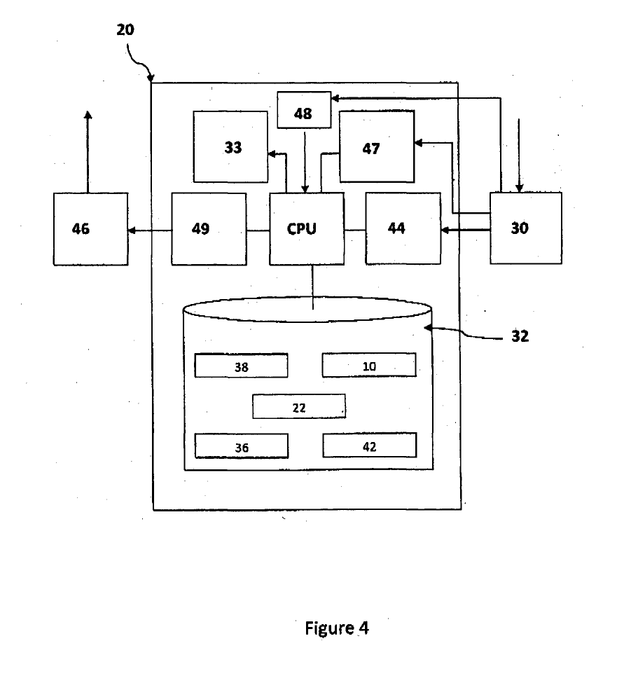

### DESCRIPTION OF A PREFERRED EMBODIMENT OF THE INVENTION

In this preferred embodiment, the invention provides an apparatus and method in order to provide a communication means for initiating a relationship between users through the use of distinctive identifying elements thereby allowing a passerby to identify and record the distinctive identifying element without directly approaching and meeting the person but indirectly through the use of a social networking system.

The invention provides an identification means 21 with a distinctive identifying element 22 which is unique to each user. Therefore the distinctive identifying element 22 for one user 10 is different to that of another user 10. The distinctive identifying element 22 can be in a range of forms such as a barcode, a radio frequency identification chip, a symbol, a series of shapes and colours, an image, a phrase or word, an alphanumerical code or in some instances can be an equation that the second person, identified as the user initiator 17, must solve in order to communicate with the first person, being the selected user 11. The distinctive identifying element 22 will need to be distinctive, unique and positioned in a personal display means 21 which provides a user initiator 17 the opportunity to clearly view and record the distinctive identifying element 22.

It is preferable that where the distinctive identifying element 22 is in the form of a barcode or code, that it contain 4 to 6 letters and/or numbers. The distinctive identifying element 22 can be generated by the communication means 20 upon completion of registration by the user 10, can be selected by the user 10 but will be examined for uniqueness and distinctiveness, can be predefined and pre-identified to the user during registration.

The personal display means 21 allows the distinctive identifying element 22 to be presented in a wide range of mediums such as a bracelet or other item of jewelry, or watch, a badge or other identifier attached to the user. Alternatively, the personal display means can be an item wearable by a user such as a t-shirt or stitched onto a pocket of a jacket, purse, backpack etc. The personal display means can also be in the form of a user's business card or introduction card, car registration plates, bumper sticker, key rings, key tags, mobile phones, mobile phone tags, temporary or permanent tattoos or the like. The introduction card can be used as part of the identification system which can be downloadable and printable from the website which illustrates the distinctive identifying element.

The personal display means 21 can further display information other than the distinctive identifying element 22 such as a trade mark or logo representing the operator of the system. Other information can also include the user's contact details in case of loss. A further embodiment may include a sounding or visual function installed into the personal display means so that the wearer is notified when someone is interested in them or has viewed their profile page.

Further to this embodiment, the personal display means may allow for instant communication between the user initiator 17 and the selected user 11. Therefore, upon the user initiator 17 observing the selected user 11 a message can be sent from one user to another. If the distinctive identifying element is not observable to the user initiator 17, this may be requested through an instant message or other telecommunication device. Alternatively, the user initiator can send the selected user their own distinctive identifying element 22. This will allow for communication between the user initiator and the selected user in a predefined vicinity.

All users 10 must register to the software, application or internet platform to which the invention is to be applied. The software, application or internet platform can be accessed via an electronic device, such as a computer and CPU, or a telecommunication device such as a mobile phone.

The registration process may provide for payment or, where payment is not required, input of promotional voucher numbers, and the inclusion of internal data 36. Such internal data 36 can include those details personal to the user 10 and kept private and confidential until the selected user 11 provides instructions to the contrary. All users 10 can set up a personal profile page and can have pre-defined parameters as to the degree to which certain individuals can view their personal page and the information held within. For example, initially upon contact at Step 1 of the process, the selected user 11 may provide for a first level of information to be disclosed as: whether they are looking for friendship, dating, business partners, intimate partners, swingers, their preferences or desired qualities in a user initiator 17 such as gender, age, career etc. Over time or at Step 6 of the process, the selected user 11 may provide for a further level of information which includes such personal information as age, birthdays, star sign, career/occupation, children, nationality, email address, mobile no etc.

The pre-defined parameters can be a series of limiting criteria entered as internal data and a selection of parameters indicates the information displayed at different levels before or once the selected user 11 has accepted a relationship with the user initiator 17.

Before forming a relationship the internal data 36 can comprise of selection criteria 38. The selection criteria can include limiting factors such as age, gender, race, occupation, career goals etc and can provide effect to narrow or eliminate contact from various user initiators. For example, upon the user initiator 17 searching the users distinctive identifying element 22 if they are excluded by the limiting factor then the selected user's details 11 may not come up as a search result or may be replaced by a message automated by the communication means, identifying that they cannot contact the selected user 11. Alternatively, the user initiator can view the initial information displayed by the selected user 11 but cannot forward a request to open communication channels between the parties. It assists in allowing the selected user to be contact by user's specific to their desires or requires.

Alternatively where the selection criteria are used once the communication channels between the parties are open in the form of profile instructions 47. An example of the profile instructions in the form of pre-defined parameters on a profile page can, in one embodiment, a series of web pages. For example, the selected users profile page can include initial information about the selected user. This is identified as the ‘Front Door’ webpage. This will allow the user initiator to firstly identify that they have located the correct selected user and, secondly, that they, in viewing the limited information available about the selected users personality or the selected users preferences of characteristics in a potential user initiator, wish to initiate contact.

For more detailed information, a message or request can be sent to the selected user and, on the consent of the selected user, the user initiator can access the ‘Living Room’ for more information, photos or other programmes such as psychological or compatibility tests.

If at this stage the user initiator still is displaying interest for the selected user and wishes to initiate contact or to obtain further information, they can send such a request to the selected user who may consent to unlimited contact with the user initiator. This will allow the user initiator access to the ‘Behind the Curtain’ web page which allows the selected user and user initiator to share information.

The user initiator 17 is the second person defined as the user 10 who contacts and initiates the interaction with the selected user 11. The selected user it, is the first person defined as the user to whom the user initiator 17 has selected as being of interest to them or viewing as a possible partner. The selected user 11 is one where in their normal course of activity are observed by a user initiator 17. The selected user 11 will usually be unaware that they have an admirer until the user initiator 17 has initiated contact with them through the use of the current invention.

The user initiator 17 can be a current user or can become a current user once they have viewed the selected user's distinctive identifying means 22, become interested in the selected user 11 and the process and therefore becomes a member. The personal display means 21 therefore provides an indirect marketing tool. However, in the preferred embodiment, it is envisaged that the user initiator 17 is a current member prior to contacting the selected user 11.

Access to the database 32 is provided by the access means 30 to allow for the entry or input of input data or data input 48 into the communications means 20 and retrieving from the database 32 details of the selected user related to the distinctive identifying element 22.

Input data 31 allows a user initiator 17, once identifying the selected users 11 distinctive identifying element 22, to input this information into a database. The input information can be inputted from the user's personal profile page in a search means 44 such as a search engine. Once inputted, the search engine can search the database for the individual with that unique distinctive identifying element 22. The search results may provide for a photograph of the selected user 11 which the selected user 11 has consented to use in their internal data in order to confirm to the user initiator 17 that they have located the correct user. Other limited information can be displayed such as an introductory line, username or a blurb identifying the key characteristics or values the selected user 11 is looking for in a prospective partner.

The data input 48 provides information regarding the user initiator such as personal information displayed in their own internal data or profile page. The access means 30, is able to receive such data input 48.

The database 32 is a medium provided by the invention to store the distinctive identifying elements 22 and illustrate and identify the users to which the distinctive identifying elements 22 represent. The database 32 can form part of the user's personal page as a search tool or can be a search tool on the website in itself so that a user initiator 17 who is not yet a member can search the identifying element to confirm that their person of interest is a member before signing up themselves.

The database 32 can comprise of such information as the profile page 42 of each user 10, the distinctive identifying element 22 and the corresponding user 10, the internal data 38 and identity of each user 10, selection criteria 38 or a combination of features thereof.

The output provided by the controlled communication system is in two forms; a first output means and a second output means.

The first output means 33 provides output data 34 which allows a user initiator to initiate communication with the selected user after the search results have been received from the input of the input data 31 into the database 32. The output data generated can provide for a means of accessing the selected users internal data such as in the form of the selected user's profile page displayed according to the user's limiting criteria. In addition, the output data 34 generated can provide for information 34 such as personal information regarding the user initiator 17 or a personal message, an automated request to invite the selected user to communicate, chat, or a request to view the user initiators personal profile page, images or photographs to obtain further information about them. The output data 34 can be in the form of internal emails or messages from one profile page to another, or an email to a user selectors allocated email account, sms or other form of communication as predefined by the user selector 11 in their internal data.

The first output means 33 including the output data 34 could be available to the selected user 11 by receiving an active communication through receipt of generated email, sms or the like. Such communication could be automatically created by the database 32. Alternatively the output 33 including the output data 34 could be available to the selected user 11 only when the selected user returns to the website associated with the database 32 to check if any communications or enquiries or requests from any user initiator wishing to initiate communication with the selected user 11.

The second output means 49 allows for the opening of communication channels 46 to the selected user. The communication channels 46 can continue to be in the form of internal emails and messages between profile pages or as specified in the internal data 36 of the selected user which can be modified or altered during the course of communication between the users. The second output means 49 further provides for the sending of data input 48 to the selected user. Such data input 48 can be examined according to the selection criteria 38 to prevent unwanted information being communicated.

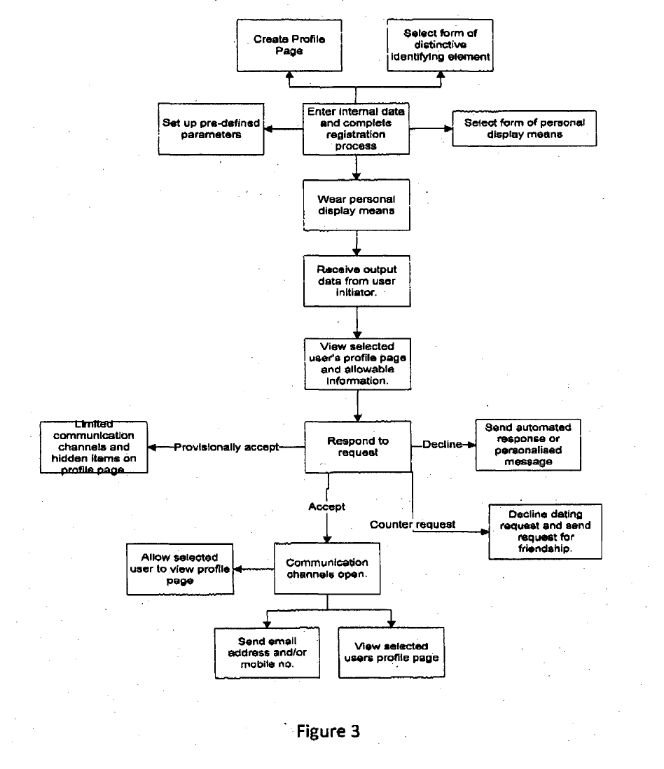

In reference to FIG. 3, upon receiving of the output data 33, the selected user 11 has the option of accepting or declining the user initiator's 17 request or invitation to extend further communication. Upon declining the user initiator's request, the user initiator 17 will receive an automated response or a personal message from the selected user 11 as to why their request was rejected. Alternatively, the invention will allow for conditional rejections whereby the selected user 11 may accept the user initiator's request provided that, for example, further personal information is provided or where the selected user 11 and user initiator 17 meet. In the preferred embodiment, the selected user 11 will want only limited information displayed to the user initiator 17 until they have communicated with them and decided whether to formally accept the user initiators 17 request over a duration of time. In another embodiment, the user selector 11 will allow the user initiator 17 with a provisional acceptance whereby the full profile of the selected user 11 is allowed but for a predefined period of time after which the selected user 11 can decide whether to reject or accept the user initiators request.

The website may further provide a method of ignoring repeat output data 34 so that users do not feel harassed or prevent users from abusing the system and sending users inappropriate information or explicit information, spam or viruses.

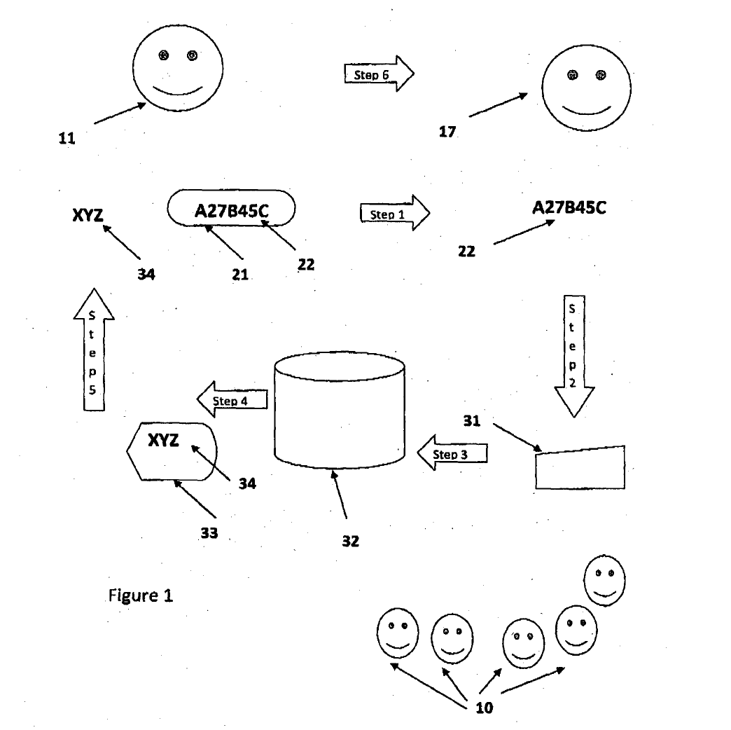

In reference to FIG. 1, the following method is outlined:

In Step 1, all users 10 are each provided with a distinctive identifying element 22. For a matter of convenience we will refer to the personal display means 21 as a bracelet and the distinctive identifying element as an alphanumerical code 22. As all users will be wearing the bracelet in Step 1 a user initiator 17, in their normal course of activities will see an individual to whom they are attracted or would like to initiate communication with. The user initiator 17 will be able, to identify, observe and record the distinctive identifying element 22 of the selected user 11.

In Step 2, once the user initiator 17 has obtained the distinctive identifying element 22 they will be able to access the database 32 through the appropriate software or internet platform where the user initiator, through a general webpage or their own personal profile page can enter the distinctive identifying element 22 as input data 31 into a search engine.

Under Step 3, once the input data is inputted into the database 32, the user initiator 17 can obtain the search results in the form of one or more users 10 which provides for limited information that the users 10 including the user selector 11 has provided.

The user selector 11 can identify and select the extent to which their information is displayed at this stage and may only wish for a username, introductory line and/or a photograph to be provided to the user initiator 17 in order to ensure that the user initiator 17 has obtained and recorded the correct distinct identifying element 22. It provides an additional verification step to ensure that misleading information in the form of photographic images are displayed.

The user initiator 11 in step 4 can then select from the pool of users 10 the user selector 11. The user initiator 17, once they have confirmed that they are initiating contact with the correct user, are able to send output data 33 to the selected user 11. The information in the output data will be reviewed by the selected user in Step 5. If the selected user 11 is interested in communicating with the user initiator 17 they can accept the request in the output data 33 which will allow access to the user selector's personal profile page and other details or communication avenues.

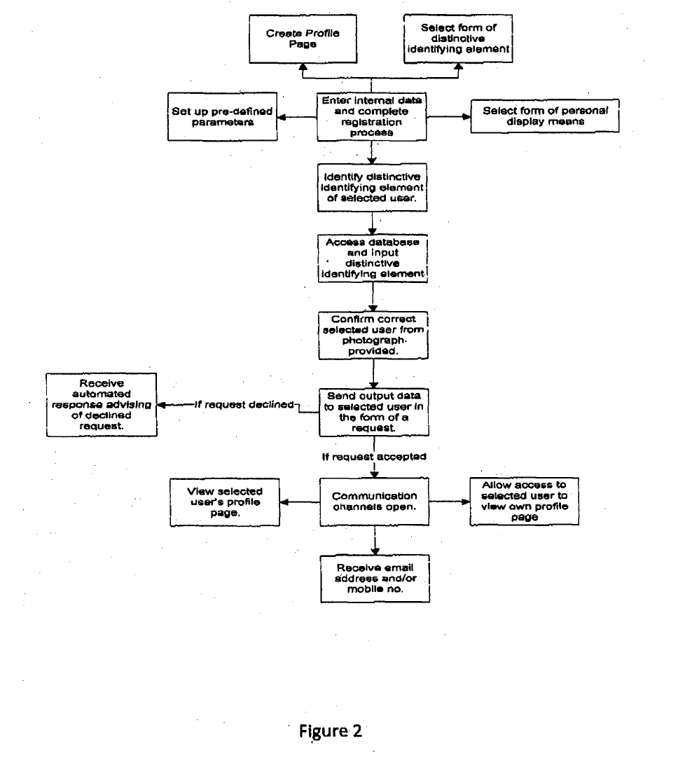

In Step 6, the selected user 11 can accept the user Initiators request 17. As in FIG. 2, once user initiators 17 request is accepted communication channels between the users is open. The personal profile page of the users can illustrate the type of communication channels available and whether these communication channels are open between one, all or selected users. If the selected user 11 rejects the user initiators request to open communication channels, the user initiator 17 can be notified in an automated response or in a message by the selected user 11 providing information or reasoning as to why their request was declined or allowing their original request for dating purposes to be accepted for friendship purposes only. Once declined, the selected user can determine whether further requests by the same user 17 will be automatically declined.

The method is subject to change as the user initiator 17 may wish to approach the user selected in Step 1 and provide them with their own distinctive identifying element 22. This can be done through the use of the introduction card which can be given to the selected user. In doing so the selected user 11 will be able to view the users account in order to skip the intermediary steps and determine at Step 6, by viewing the users internal data as to whether they wish to communicate further.

While we have described herein a particular embodiment of an identification means, it is further envisaged that other embodiments of the invention could exhibit any number and combination of any one of the features previously described. However, it is to be understood that any variations and modifications which can be made without departing from the spirit of the invention are included within the scope thereof.

1. A system of controlled communication providing a method of identifying and meeting unknown persons including the steps of:
a. providing a personal display means for wearing by a first person;
b. providing a distinctive identifying element on the personal display means allowing a second person to identify a distinctive identifying element of a viewed display means;
c. providing a database for receiving details from a plurality of people related to one of a plurality of the identified distinctive identifying elements of a plurality of personal display means each associated and wearable by respective ones of the plurality of people including the first person;
d. allowing the second person to enter details of the identified distinctive identifying element of the viewed display means by an access means to the database; and
e. the access means retrieving from the database details of first person related to the distinctive identifying element of the viewed display means;
f. the access means receiving details from the second person;
g. automatically providing details to the first person of the identification by the second person and details of the second person allowing review of the second person by the first person and selective contact by the first person to the second person;
whereby a communication between unrelated first and second persons can be undertaken with each having opportunity for review prior to selective interaction between each other.

2. (canceled)

3. A system of controlled communication providing a method of identifying and meeting unknown persons according to claim 1 whereby the personal display means is a bracelet, a watch, badge, a t-shirt, a jacket or pant pocket, backpack, business car, car registration plates, bumper sticker, key rings, mobile phones, mobile phone tags, temporary or permanent tattoos or a combination thereof, and has a distinctive identifying element and which is an identification means.

4. A system of controlled communication providing a method of identifying and meeting unknown persons according to claim 1 whereby the personal display means can allow instant communication between the user initiator and the selected user.

5. (canceled)

6. A system of controlled communication providing a method identifying and meeting unknown persons according to claim 1 whereby the distinctive identifying element is unique.

7. A system of controlled communication providing a method of identifying and meeting unknown persons according to claim 6 whereby the distinctive identifying element is a series of colours, shapes and/or numbers or other identity code means whereby the size and type of distinctive identifying element allows viewing from a distance such that a passerby can determine the distinctive identifying element without necessarily approaching and meeting the person.

8. A system of controlled communication providing a method of identifying and meeting unknown persons according to claim 1 whereby the distinctive identifying element is a radio frequency identification chip, barcode, symbol, series of shapes and colours, an image, phrase or alphanumerical codes or a combination thereof.

9. A system of controlled communication providing a method of identifying and meeting unknown persons according to claim 1 whereby the users must register, the registration process comprising the steps of:
a. providing internal data;
b. providing payment; and
c. creating a personal profile page.

10. A system of controlled communication providing a method of identifying and meeting unknown persons according to claim 9 whereby the internal data includes the user's personal details, the user's privacy settings, user's information to be disclosed on their websites including their preferences or desired qualities in a user initiator.

11. A system of controlled communication providing a method of identifying and meeting unknown persons according to claim 9 whereby the internal data includes a user's profile page.

12. A system of controlled communication providing a method of identifying and meeting unknown persons according to claim 1 providing a database.

13. A system of controlled communication providing a method of identifying and meeting unknown persons according to claim 12 whereby the database stores the distinctive identifying elements and users details corresponding to the distinctive identifying element.

14. A system of controlled communication providing a method of identifying and meeting unknown persons according to claim 12 whereby the database provides a search means in which to find the details of the user correlating to the searched distinctive identifying element.

15. A system of controlled communication providing a method of identifying and meeting unknown persons according to claim 1, whereby:
a. the distinctive identifying element on the personal display means allows the second person to identify the distinctive identifying element of the viewed display means without directly approaching the first person but indirectly through the use of the system of controlled communication;
b. providing the details of the second person to the first person in the form of a request by the second person to the first person and allowing review of the request of the second person by the first person; and,
c. selectively accepting the request of the second person by the first person to open communication channels between the second person and the first person.

16. A system of controlled communication providing a method of identifying and meeting unknown persons including the steps of:
a. providing a personal display means for wearing by a first person;
b. providing a distinctive identifying element on the personal display means allowing a second person to identify a distinctive identifying element of a viewed display means without directly approaching the first person but indirectly through the use of the system of controlled communication;
c. providing a database for receiving details from a plurality of people related to one of a plurality of the identified distinctive identifying elements of a plurality of personal display means each associated and wearable by respective ones of the plurality of people including the first person;
d. allowing the second person to enter details of the identified distinctive identifying element of the viewed display means by an access means to the database;
e. the access means retrieving from the database details of first person related to the distinctive identifying element of the viewed display means;
f. providing a request by the second person to the first person allowing review of the request of the second person by the first person;
g. selectively accepting the request of the second person by the first person to open communication channels between the second person and the first person
whereby communication between unrelated first and second persons can be undertaken with each having opportunity for review prior to selective interaction between each other.

17. A communication means for controlled communication including:
a. an access means for inputting into the communication means a distinctive identifying element of a personal display means of one of a plurality of users;
b. a database of a collection of data of user information associated with respective distinctive identifying elements of the plurality of users;
c. a search means for receiving the inputted distinctive identifying element and comparing with the plurality of distinctive identifying elements being stored in the database allowing a search to identify the selected user corresponding to the determined distinctive identifying element;
d. a first output means for outputting from the database providing a means of accessing a selected user's internal data and being visible to a initiating user for determination and in a position adequately representing the selected user;
e. the access means able to receive a further input from the initiating user to provide input data of user information of the initiating user;
f. a second output means for opening of communication channel to the selected user and for sending the data input of user information of the initiating user;
whereby the controlled communication along communication channels between the user initiator and the selected user assists in the development of an online relationship at the selective choice of the selected user reviewing the data of user information of the initiating user.

18. A system of controlled communication according to claim 1, having a system of selective communication comprising of:
a. providing input data by a user to generate the allocation of a distinctive identifying element to the user;
b. displaying the distinctive identifying element on at least one identification means for transporting by the user;
c. providing a database storing the distinctive identifying element allocated to the user and allowing access to a limited profile of the user's input data;
d. whereby the system of selective communication allows a relationship between at least two users through the use of the distinctive identifying elements thereby allowing one of the at least two users to identify and record the distinctive identifying element without directly approaching the second of the at least two users but indirectly through the use of the system of selective communication.

19. (canceled)

20. (canceled)

21. (canceled)

22. (canceled)

23. (canceled)

24. A system of selective communication according to claim 16 whereby the personal display means can allow instant communication between the user initiator and the selected user in a predefined vicinity.

25. (canceled)

26. (canceled)

27. (canceled)

28. (canceled)

29. (canceled)

30. (canceled)

31. (canceled)

32. (canceled)

33. A system of selective communication according to claim 16 providing for the use of the identification means in the system of selective communication, the use comprising of a personal display means with a distinctive identifying element such that a user initiator can determine the distinctive identifying element without necessarily approaching and meeting the selected user and upon determining the distinctive identifying element the user initiator can search the database to access a selected user's internal data and initiate communication.

34. A system of selective communication according to claim 16 providing a use of the identification means in the system of selective communication comprising of:
a personal display means with a distinctive identifying element;
the distinctive identifying element being visible to a user initiator for determination and in a position adequately representing the selected user;
the distinctive identifying element being stored in the database allowing a search to identify the selected user corresponding to the determined distinctive identifying element;
the database providing a means of accessing a selected user's internal data and opening of communication channels;
whereby the opening of communication channels between the user initiator and the selected user assists in the development of an online relationship.

35. (canceled)

36. (canceled)

37. A system of selective communication according to claim 34 whereby the database provides a search means in which to find the details of the user correlating to the searched distinctive identifying element.

38. (canceled)

39. (canceled)
